(19) United States
(12) Patent Application Publication
(10) Pub. No.: US 2009/0107874 A1
(43) Pub. Date: Apr. 30, 2009

(54) ADJUSTABLE DRAIN PAN FOR WASHING MACHINES AND OTHER HOME APPLIANCES

(75) Inventor: Kevin WOLFE, Heidelberg (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: RAINBOW PRECISION INC., Elmira (CA)

(21) Appl. No.: 12/258,550

(22) Filed: Oct. 27, 2008

Related U.S. Application Data
(60) Provisional application No. 60/982,774, filed on Oct. 26, 2007.

(51) Int. Cl. B65D 1/34; B23P 19/04

(52) U.S. Cl. 206/557; 29/700

(57) ABSTRACT

A drain pan kit, comprising four pan sections, each having a flat portion and raised edges along two adjacent sides, whereby a custom-sized drain pan can be assembled by overlapping the four pan sections and respective raised edges, and securing the sections to each other along respective joint lines.

### CROSS-REFERENCE TO OTHER APPLICATIONS

This application claims the benefit of priority of U.S. Provisional Patent Application No. 60/982,774 filed Oct. 26, 2007, which is incorporated herein by reference in its entirety.

### FIELD OF THE INVENTION

This invention relates to drainage pans and more specifically to a drain page for catching leaks, dust, grease, crumbs or other particulate matter.

### BACKGROUND OF THE INVENTION

In apartments in particular, tenants can become irate when moisture leaks through the ceiling from another tenant above, due to a leak from an appliance. The tenant with the leak may have liability concerns as well, for damage to floors and ceilings below.

A known solution is to place a tray under the offending appliance or other potential mess. However, since different appliances can have different tray size needs, manufacturers and retailers must produce and stock many different size trays, if the consumer market is to be satisfied. If only a few tray sizes are provided, and if consumers cannot find a tray of the exact size they want, they may not make a purchase, instead of purchasing a tray which is not optimum for the intended use.

In addition to leakage problems, there are often issues with grease, so-called “dust bunnies”, leaky containers, garbage cans, recycle bins etc. producing unwanted messes around the home or workplace.

Therefore, there is provided a novel adjustable drain pan for catching liquid leaks or particulate matter.

### SUMMARY OF THE INVENTION

In view of the above, it is an aspect of this invention to provide an adjustable or customizable drainage pan. In another embodiment, a kit which permits consumers to readily assemble a custom-sized drain pan or tray is also contemplated.

More specifically, this invention relates to an adjustable drain pan for catching leaks, dust, grease, crumbs, etc. from appliances especially but not limited to washing machines, dishwashers or refrigerators. The adjustable drainage pan can also be used to capture liquids or particulate matter under items such as a garbage can, a recycling box or even as a shoe mat.

In one embodiment, the pan is designed to be installed under an appliance that has the potential to leak fluids of any type. Examples include, but are not limited to a washing machine, dishwasher or water cooler. There may be many reasons for this leak such as the age of the appliance or a malfunction of the appliance.

In accordance with an aspect of the invention, a kit is provided, having four panel sections, each with two adjoining raised edges. By suitably overlapping, or interlocking, the four sections as described in the detailed description below, and then gluing or otherwise sealing the four sections together, a custom-sized drain pan can be created.

Preferably, the four sections are identical, so that manufacturing is facilitated without multiple molds for multiple parts. Preferably, each section has measurement lines marked thereon, to facilitate assembling the drain pan to a specific size.

The result is an easy to assemble drain pan which retailers and consumers alike will appreciate. Building superintendents and maintenance companies may particularly appreciate the invention as part of their maintenance programs.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is a perspective view of an exemplary embodiment, with three sections in place and one section about to be put in place;

FIG. 2 is a plan view of one of the trays, showing dimensional markings;

FIG. 3 is a top view of an assembled drainage pan;

FIG. 4 is a flowchart outlining a method of assembling the drainage pan; and

FIG. 5 is a perspective view of a kit for a custom-sized drainage pan.

### DETAILED DESCRIPTION OF THE INVENTION

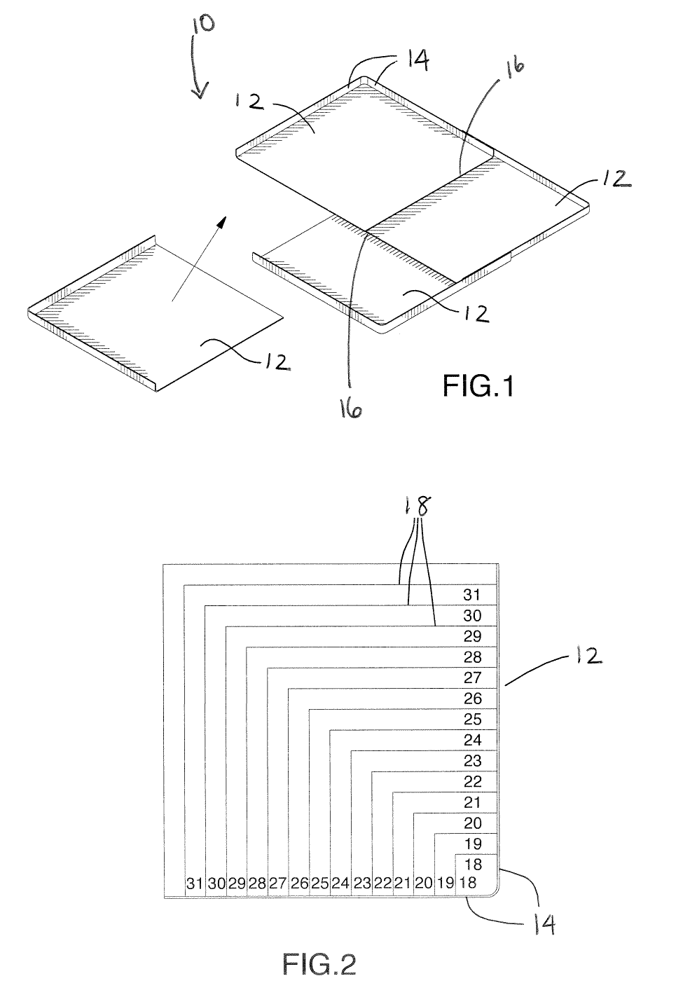

Turning to FIG. 1, a perspective view of a disassembled drainage pan is provided. The drainage, or drain, pan 10 includes a plurality of sections 12, preferably four (4) identical sections. The sections 12 are capable of being interlocked, or overlapped, with each other to provide the assembled drain pan. In the preferred embodiment, the drainage pan can either be rectangular or square in shape. As will be understood, other custom-sized shaped drain pans are contemplated. An example of one of the sections 12 is shown in FIG. 2.

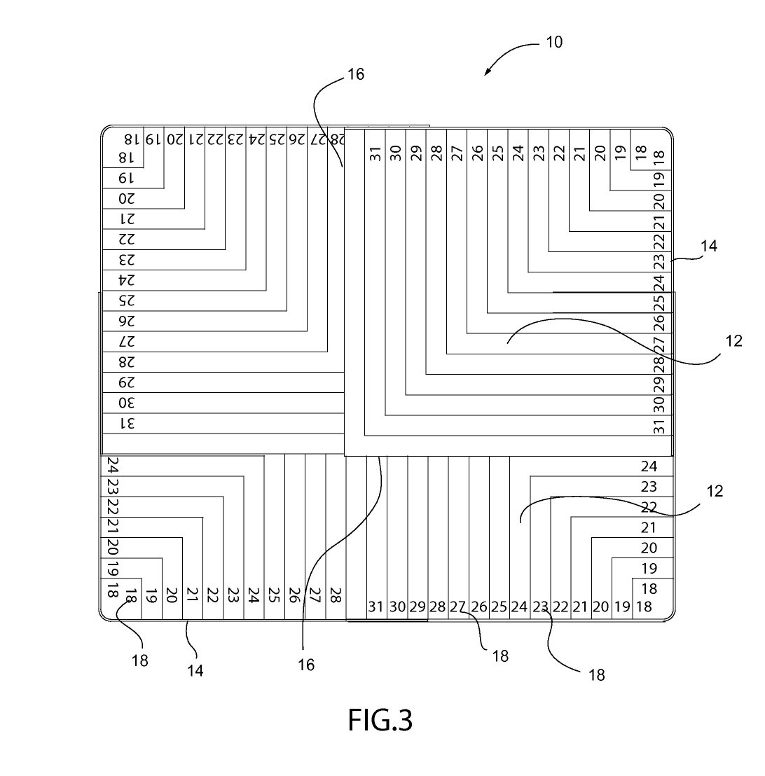

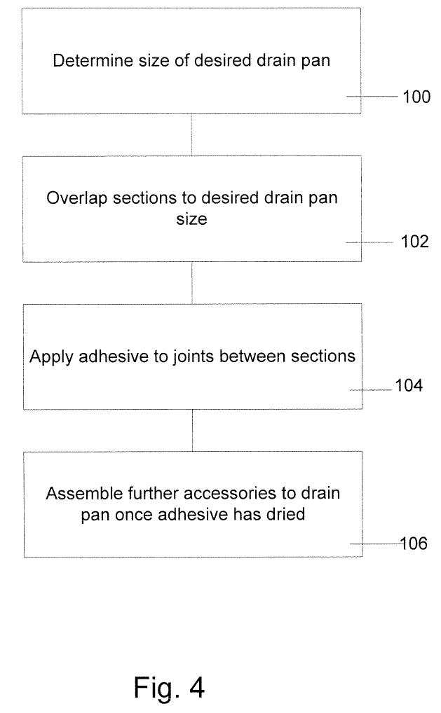

Each of the sections 12 includes a base 13 having connected thereto two adjoining, or adjacent, raised or vertical edges 14 on an edge of the base 13, such that when all of the sections 12 are joined, or interlocked, an enclosed drainage pan is formed with a continuous raised edge surrounding a base of the pan. A top view of an assembled pan 10 is shown in FIG. 3.

In this manner, any liquid which is captured during a leak is maintained within the drainage pan and does not leak out onto the surface on which rests as the raised edges 14 allow for the pan to be capable of holding liquid leaks. The pan can also be used to catch other items such as dust bunnies or particulate matter. The presence of the raised edges 14 provides an added benefit in that when the contents of the pan are being carried for dispersal, they do not fall or leak out of the pan 10.

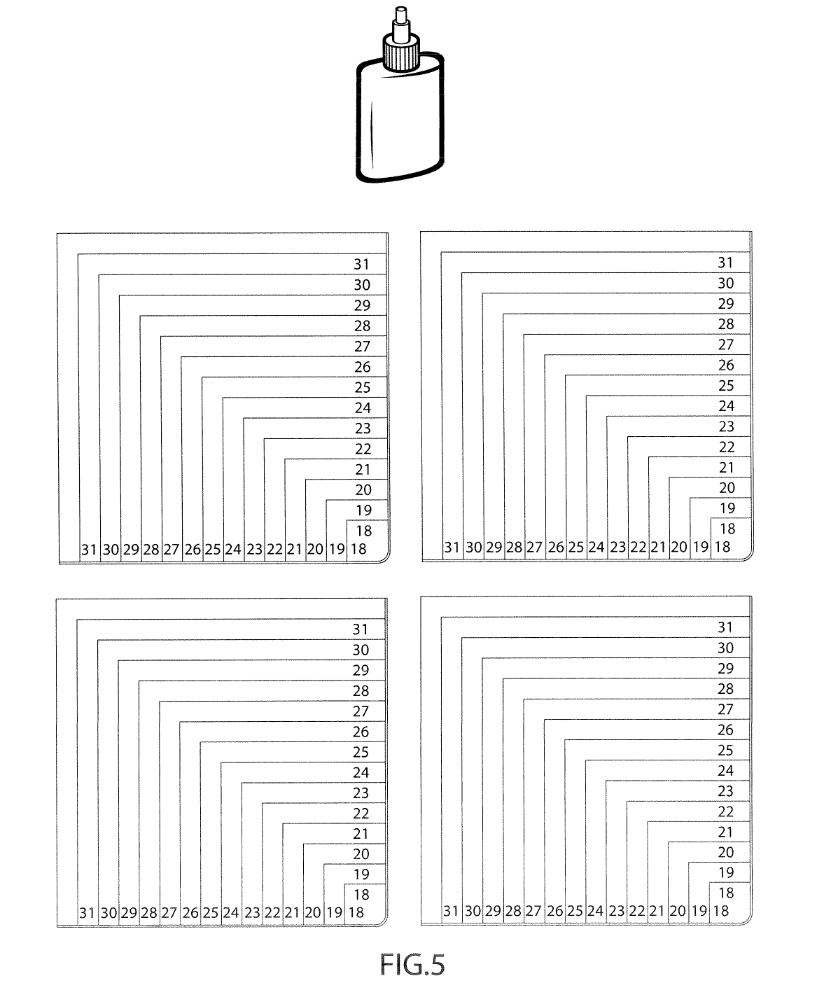

In order to assemble the pan 10, the individual sections 12 are overlapped and then attached using any suitable glue or sealant to bond the sections 12 together along joints 16 formed between the sections. In scenarios where the pan is used to catch leaks from an appliance, the joints 16 must be sealed in a water-tight fashion. For other applications, this may not be necessary though often desirable. In the preferred embodiment, the kit (as shown in FIG. 5) includes a glue or sealant 19 along with the sections 20 so that the user/consumer has all the necessary items on hand to assemble the pan 10 after its purchase. Obviously, for larger-scale uses, such as where a building landlord may want to install dozens or hundreds of pans, the sections 20 can be provided in bulk and the glue or sealant 19 purchased separately in whatever quantity was deemed necessary or desirable. Also the type of glue or sealant required for the specific use can also be selected.

As shown in FIG. 2, each of the sections 12 can be marked with dimension lines 18, such that if one wanted a pan that was 20 inches by 30 inches, one would simply overlap the sections 20 to line up with the “20” line in one direction and the “30” line in the other. In FIG. 3, the assembled pan 10 has a size of “28” inches by “24” inches. In this manner, the user can produce a custom sized pan depending on the footprint of the selected appliance or for whatever application is desired.

In assembly, a determination is made as to the required size of the pan for the selected appliance. Although the maximum size is shown to be 31 inches by 31 inches, it will be understood that smaller or larger sections are contemplated. Once the size determination is made (step 100), the sections 12 are then overlapped so that the correct size is produced (step 102). Once this is complete, the user then seals the joints (step 104) between the sections 12 by applying glue or sealant to the joint. The glue or sealant is then left to dry and once dry, the pan is deemed to be assembled and ready for use. The user can then place the assembled pan at the desired location, such as underneath the selected appliance so that leaks, dust or particulate matter can be captured.

After the drainage pan has been assembled, further accessories can be attached to the pan (step 106). For instance, a trap or a drain, or both, can be installed in the bottom of the drainage pan so that if the drainage pan is full of liquid, the liquid can travel out of the drainage pan through the drain. The trap can be used to capture any particulate matter within the liquid. Also, a sensor can be installed which can generate an alarm when the level of matter in the drainage pan reaches a predetermined level. Also, a side drain can be installed that allows liquid to be removed, or exit, after a certain level has been reached.

Therefore, there is provided a customizable drainage pan for collecting liquids or particulate matter which is easy to package and to install. This is an improvement over current drainage pans which do not provide any opportunity to customize the drainage pan. Furthermore, by having sections, the packaging for the drainage pan is reduced as each of the sections can rest within each other.

Preferred and exemplary embodiments of this invention are described herein. Variations of those embodiments may become apparent to those of ordinary skill in the art upon reading the foregoing description. It is expected that skilled persons will employ such variations as appropriate, and it is expected that the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A drain pan kit, comprising four pan sections, each having a flat portion and raised edges along two adjacent sides, whereby a custom-sized drain pan can be assembled by overlapping the four pan sections and respective raised edges, and securing the sections to each other along respective joint lines.

2. A drain pan kit as in claim 1, wherein each said pan section is marked with alignment lines corresponding to different drain pan dimensions, whereby a drain pan of a desired dimension can be assembled by aligning said drain pan sections with the alignment lines corresponding to the desired dimensions.

3. A drainage pan for collecting liquids or particulate matter comprising:
a plurality of sections, each section including a pair of adjacent vertical edges;
whereby the sections can be interlocked to form a drainage pan enclosed by the vertical edges.

4. The drainage pan of claim 3 wherein there are four sections.

5. The drainage pan of claim 3 wherein each of the plurality of sections include alignment lines to indicate the size of the drainage pan.

6. The drainage pan of claim 3 wherein the drainage pan has four sides.

7. The drainage pan of claim 6 wherein the pan is a rectangle or a square.

8. A method of assembling a drainage pan comprising:
interlocking a plurality of sections, each section including a pair of adjacent vertical edges, such that the sections form a drainage pan enclosed by the vertical edges; and
adhering joints, created by the interlocking of the plurality of sections with an adhesive to assemble the drainage pan.

9. The method of claim 8 further comprising, before interlocking, the step of:
determining a desired size of the drainage pan.

10. The method of claim 9 wherein the step of interlocking comprises:
overlapping the plurality of sections based on alignment lines provided on a surface of each section.

11. The method of claim 9 further comprising:
assembling accessories to the drainage pan.
